(19) United States
(12) Patent Application Publication
(10) Pub. No.: US 2026/0370468 A1
(43) Pub. Date: Nov. 19, 2026

(54) ENCRYPTION SCHEMES FOR COMMUNICATION OF ERROR CORRECTION DATA

(71) Applicant: Micron Technology, Inc., Boise, ID (US)

(72) Inventors: Lance W. Dover, Fair Oaks, CA (US); Randall J. Rooney, Boise, ID (US); Sujeet V. Ayyapureddi, Boise, ID (US)

(21) Appl. No.: 19/408,148

(22) Filed: Dec. 3, 2025

Related U.S. Application Data
(60) Provisional application No. 63/738,974, filed on Dec. 26, 2024.

(51) Int. Cl. H04L 9/30

(52) U.S. Cl. CPC H04L 9/304; H04L 2209/34

(57) ABSTRACT

Methods, systems, and devices for encryption schemes for communication of error correction data are described. A memory system may include an error correction module that is configured to encrypt data and parity information generated by system-level error correction circuitry of the memory system prior to communicating the data and parity information via a data bus coupled with the error correction module. For example, the error correction module may be configured with one or more encryption schemes that are enabled for encryption of the data and the parity information by the error correction module prior to communication of the data and the parity information external to the error correction module. In some examples, the error correction module may encrypt the data and the parity information prior to transmission of the data and parity information to a host system, for storage in one or more memory dies, or both.

### CROSS REFERENCE

The present Application for Patent claims priority to U.S. Patent Application No. 63/738,974 by Dover et al., entitled “ENCRYPTION SCHEMES FOR COMMUNICATION OF ERROR CORRECTION DATA,” filed Dec. 26, 2024, which is assigned to the assignee hereof, and which is expressly incorporated by reference in its entirety herein.

### TECHNICAL FIELD

The following relates to one or more systems for memory, including encryption schemes for communication of error correction data.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports encryption schemes for communication of error correction data in accordance with examples as disclosed herein.

FIG. 2 shows an example of a system that supports encryption schemes for communication of error correction data in accordance with examples as disclosed herein.

FIG. 3 shows an example of a process flow that supports encryption schemes for communication of error correction data in accordance with examples as disclosed herein.

FIG. 4 shows an example of a process flow that supports encryption schemes for communication of error correction data in accordance with examples as disclosed herein.

FIG. 5 shows a block diagram of a memory system that supports encryption schemes for communication of error correction data in accordance with examples as disclosed herein.

FIG. 6 shows a flowchart illustrating a method or methods that support encryption schemes for communication of error correction data in accordance with examples as disclosed herein.

### DETAILED DESCRIPTION

Some memory systems may include multiple memory dies (e.g., memory devices). Each memory die may include one or more memory arrays for storage of data. In some examples, one or more of the memory dies may be configured with on-die error correction capabilities (e.g., on-die error correction code (ECC)) to correct errors when reading and writing data to the die. Additionally, or alternatively, a memory system may include system-level error correction circuitry that aggregates parity information (e.g., parity bits) from the multiple memory dies to perform error correction at a system-level (e.g., a module level). The system-level error correction circuitry may be implemented in an error correction module (e.g., a data buffer or some other circuitry configured to perform error detection and correction) that facilitates the transfer of and correction of data between the multiple memory dies and a host system. That is, instead of correcting data on each memory die, data from the multiple memory dies may be transferred to the system-level error correction circuitry at the error correction module and combined for error correction before being transferred to a host system. Data and parity information generated by the system-level error correction circuitry may be transmitted via one or more data buses coupled with the error correction module to one or more entities coupled with the error correction module (e.g., to the host system or to the memory dies for storage). However, data and parity information that is transmitted from the system-level error correction circuitry via the one or more data buses may be susceptible to unauthorized access or snooping, which may avail the data and parity information to malicious actors or unauthorized users.

In accordance with examples described herein, the error correction module may be configured to encrypt data and parity information generated by the system-level error correction circuitry prior to communicating the data and parity information via one of the data buses coupled with the error correction module. For example, the error correction module may be configured with one or more encryption schemes that are enabled for encryption of the data and the parity information by the error correction module prior to communication of the data and the parity information external to the error correction module. In some examples, the error correction module may encrypt the data and the parity information according to a first shared key that is shared between the error correction module and one or more of the memory dies. During exchanges of data between the error correction module and the memory dies, data and parity information communicated via the data bus may be encrypted according to the first shared key. Additionally, or alternatively, the error correction module may encrypt the data and the parity information according to a second shared key that is shared between the error correction module and the host system. During exchanges of data between the error correction module and the host system, data and parity information communicated may be encrypted according to the second shared key. The first shared key and the second shared key may be associated with a same encryption scheme or may be associated with different encryption schemes (e.g., encryption algorithms, types of encryption, levels or strengths of encryption, or any combination thereof).

In some examples, the memory dies in the memory system may have a capability to perform encryption or decryption according to the first shared key. In such examples, the memory dies may decrypt the data and parity information received from the error correction module prior to storing the data and parity information unencrypted. Alternatively, the memory dies may not decrypt the data and parity information received from the error correction module, and data stored to the memory dies may be in an encrypted form.

In addition to applicability in memory systems described herein, techniques for module-level encryption of error correction data may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by utilizing encryption for secure transfer of data within and external to the memory system, which may prevent or mitigate unauthorized access to data or other information, such as error correction data (e.g., parity information) that is critical to operation of the memory system, among other benefits.

Features of the disclosure are illustrated and described in the context of systems. Features of the disclosure are further illustrated and described in the context of process flows, block diagrams, and flowcharts.

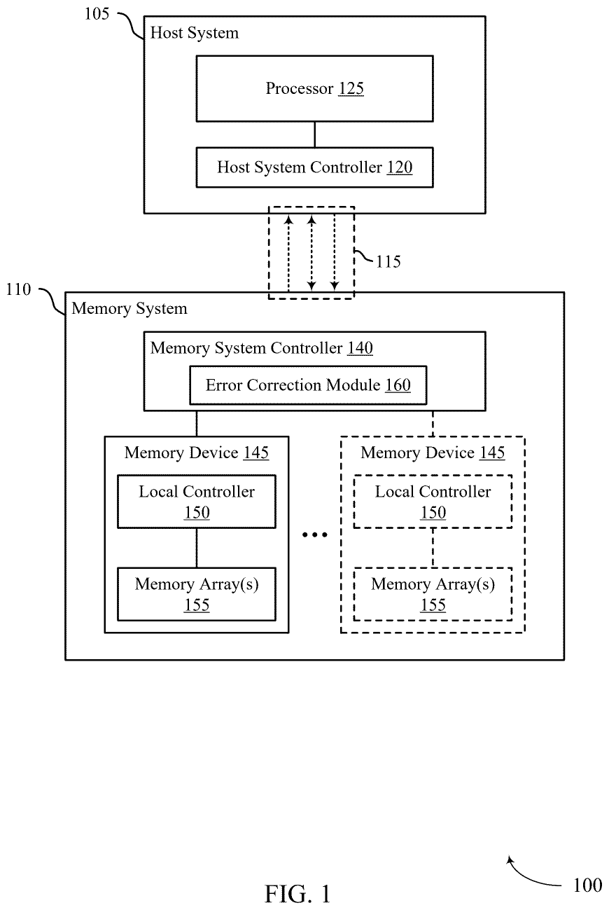

FIG. 1 shows an example of a system 100 that supports module-level encryption of error correction data in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

In some examples, one or more of the memory devices 145 may be configured with on-die error correction capabilities (e.g., on-die ECC) to correct errors when reading and writing data to the die). Additionally, or alternatively, a memory system 110 may include system-level error correction circuitry that aggregates parity information (e.g., parity bits) from the multiple memory devices 145 to perform error correction at a module-level. The system-level error correction circuitry may be implemented in an error correction module 160 (e.g., a data buffer, the memory system controller 140) that facilitates the transfer of data between the multiple memory dies (e.g., memory devices 145) and a host system 105. That is, instead of correcting data on each memory device 145, data from the multiple memory devices 145 may be transferred to the system-level error correction circuitry at the error correction module 160 and combined for error correction before being transferred to the host system 105. Data and parity information generated by the system-level error correction circuitry may be transmitted via one or more data buses coupled with the error correction module 160 to one or more entities external to the error correction module 160 (e.g., to the host system 105 or to the memory devices 145 for storage). However, data and parity information that is transmitted from the system-level error correction circuitry via the one or more data buses may be susceptible to unauthorized access or snooping, which may avail the data and parity information to malicious actors or unauthorized users.

In accordance with examples described herein, the error correction module 160 may be configured to encrypt data and parity information generated by the system-level error correction circuitry prior to communicating the data and parity information via one of the data buses coupled with the error correction module 160. For example, the error correction module 160 may be configured with one or more encryption schemes that are enabled for encryption of the data and the parity information by the error correction module 160 prior to communication of the data and the parity information external to the error correction module 160. In some examples, the error correction module 160 may encrypt the data and the parity information according to a first shared key that is shared between the error correction module 160 and the memory devices 145. During exchanges of data between the error correction module 160 and the memory devices 145, data and parity information communicated via the data bus may be encrypted according to the first shared key. Additionally, or alternatively, the error correction module 160 may encrypt the data and the parity information according to a second shared key that is shared between the error correction module and the host system 105. During exchanges of data between the error correction module 160 and the host system 105, data and parity information communicated may be encrypted according to the second shared key. The first shared key and the second shared key may be associated with a same encryption scheme or may be associated with different encryption schemes.

In some examples, the memory devices 145 in the memory system may have a capability to perform encryption or decryption according to the first shared key. In such examples, the memory devices 145 may decrypt the data and parity information received from the error correction module prior to storing the data and parity information unencrypted. Alternatively, the memory devices may not decrypt the data and parity information received from the error correction module, and data stored to the memory devices 145 may be in an encrypted form.

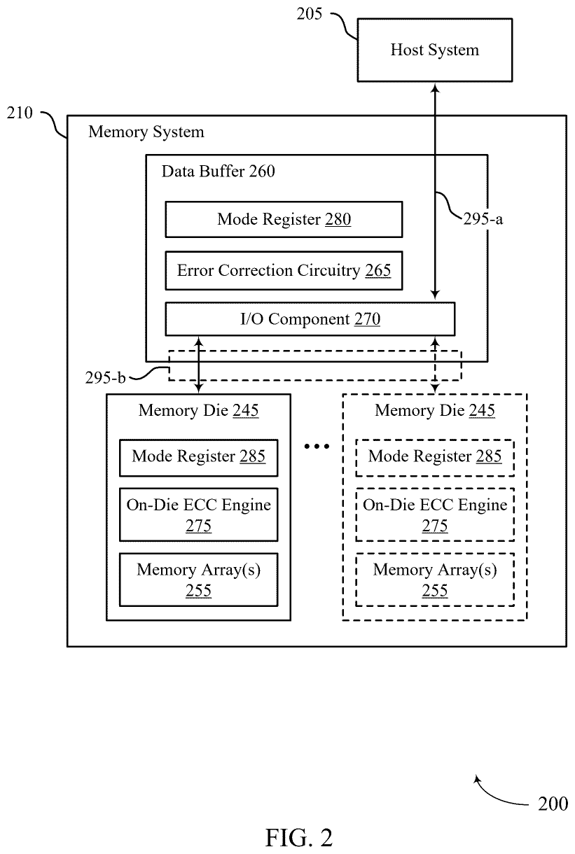

FIG. 2 shows an example of a system 200 that supports module-level encryption of error correction data in accordance with examples as disclosed herein. The system 200 represent an example of a system 100 or one or more components thereof. As described herein, the system 200 may include a memory system 210 that supports system-level (e.g., module-level) error correction within a data buffer 260 before data is conveyed to a host system 205. The memory system 210 and the host system 205 may represent examples of corresponding systems as described herein, including with reference to FIG. 1.

The memory system 210 may represent an example of a module including one or more memory dies 245, which may represent examples of the memory devices 145 described with reference to FIG. 1. Each of the memory dies 245 may include one or more memory arrays 255 configured to store data, parity bits, metadata, or the like. In some examples, each of the memory dies 245 may also include a respective on-die ECC engine 275, which may represent an example of error correction circuitry configured to detect errors, correct errors, or both within the data stored to the memory arrays 255 of the memory die 245.

The memory system 210 may include a memory system controller 140, as described and illustrated with reference to FIG. 1. In this example, the memory system 210 may additionally include the data buffer 260. The data buffer 260 may be coupled with the memory system controller 140, in some examples, and may be configured to transfer and buffer data between the host system 205 and the memory dies 245. All data that enters the memory system 210 from the host system 205 or that is transferred to the host system 205 from the memory system 210 may be transferred through the data buffer 260. For example, the data buffer 260 may include or otherwise be coupled with an I/O component 270 configured to facilitate the transfer of data to and from the memory system 210 via one or more channels, such as the one or more channels 115 described with reference to FIG. 1 (e.g., a link, channels of a data bus 295). For example, the I/O component 270 may be configured to communicate with the host system 205 via a data bus 295-a and with the memory dies 245 via a data bus 295-b. The data buffer 260 may thereby be the point where all data leaving the memory system 210 to the host system 205 (e.g., system on chip (SoC)) passes through.

Techniques described herein provide for a system-level error correction functionality within the data buffer 260 or other circuitry within the system 200. That is, the data may be corrected at a system level within the data buffer 260 or by other system-level circuitry before the data is transferred via the data bus 295-a to the host system 205, which may improve performance, in some examples. For example, transferring the parity bits from one or more of the memory dies 245 configured to store parity information to the data buffer 260 may consume less power and overhead than transferring the parity bits off of the memory system 210 to the host system 205. Shipping the extra bits (e.g., 80 extra parity bits, or some other quantity) to the host system 205 may increase energy and overhead. Additionally, or alternatively, exposing the parity bits outside of the memory system 210 may pose security risks. Since the data buffer 260 is local to the memory system 210, the energy expended to move the extra bits may be less than energy to ship the bits to the host system 205, and security within the memory system 210 may be maintained.

Thus, as described herein, the data buffer 260 may receive, via the data bus 295-bin response to a read command, data from one or more of the memory dies 245, as well as one or more parity bits from the parity memory dies 245 (e.g., the memory dies 245 that only store parity information). The data buffer 260 may include the error correction circuitry 265, which may be configured to perform an error detection and correction operation on the data using the parity bits. Although shown as being included within the data buffer 260, it is to be understood that the error correction circuitry 265 may be included elsewhere with the memory system 210. For example, the error correction circuitry 265 may be included within some other component within the memory system 210 or may be distributed across components within the memory system 210. The error detection and correction operation may be performed in accordance with one or more different algorithms or techniques. For example, the error correction circuitry 265 may include one or more logic components configured to support (e.g., execute) ECC, error-detecting code (EDC), other algorithms, or any combination thereof. The I/O component 270 within the data buffer 260 may send the corrected data to the host system 205 via the data bus 295-a after the error correction is performed. In some examples, the I/O component 270 may transfer one or more bits of metadata with the data to indicate that system-level error correction was performed, to indicate whether the errors were corrected or not, to indicate an address of the data, or other information associated with the data. The host system 205 may thereby receive the data with an indication of where error correction was performed, and may determine how to address any potential errors the host system 205 may detect accordingly. It may be beneficial to have all correction capability in the buffer using all of the parity bits retrieved from the memory dies 245. Such system-level error correction may be performed in addition to the on-die error correction, in some examples.

Additionally, or alternatively, techniques described herein may provide for one or more of the on-die ECC engines to be turned off or otherwise disabled, such that the extra parity bits within each memory die 245 may be transferred to the data buffer 260 via the data bus 295-b to enhance the system-level error correction. For example, each memory die 245 may include one or more mode registers 285 configured to indicate whether on-die error correction is enabled or disabled.

If the on-die error correction is disabled at one or more of the memory dies 245, those memory dies may be configured to transfer extra on-die parity bits stored at the memory dies 245 to the data buffer 260 via the data bus 295-b. For example, when a read command is received, a memory die 245 may retrieve the requested data and transfer the requested data in addition to one or more of the on-die parity bits to the data buffer 260 via the data bus 295-b. The data buffer 260 may use the extra parity bits to perform, by the error correction circuitry 265, the error detection and correction operations. The extra bits (e.g., eight bits from each memory die 245, or 16 bits from each memory die 245, for example) may improve an accuracy and reliability of the system-level error correction. For example, the error correction circuitry 265 may be able to detect and correct an increased quantity of errors with the increased quantity of parity bits. In some examples, if the detection capabilities of the error correction circuitry 265 are increased, the error correction circuitry 265 may detect one or more errors that the error correction circuitry 265 may not be capable of correcting. In such cases, the error correction circuitry 265 may send the data, along with metadata, to the host system 205 via the data bus 295-a, where the metadata may indicate that there are uncorrected errors.

By transferring and aggregating all of the parity bits within the memory system 210 at the data buffer 260, the data buffer 260 and error correction circuitry 265 within the data buffer 260 may support error correction for larger portions of data at a time. For example, if an entire memory die 245 is corrupted or otherwise goes down, the increased quantity of parity bits may facilitate reconstruction and correction of the whole memory die 245 by the error correction circuitry 265 at the system level (e.g., chip kill may be replicated in the data buffer 260).

The system-level error correction may be changed dynamically or prior to deployment of the memory system 210. For example, the memory dies 245 may each include a respective mode register 285 that may be set to a certain value during manufacture of the memory system 210, or dynamically throughout operation of the memory system 210. A value of the mode registers 285 may indicate an error correction mode of the memory dies 245 selected from multiple candidate error correction modes. A first value of the mode register 285 may indicate that on-die error correction is enabled, and a second value of the mode register 285 may indicate that on-die error correction is disabled. In some examples, one or more other values may indicate some intermediate level of error correction. The data buffer 260 may similarly include or otherwise be coupled with a mode register 280, which may be configured to indicate whether system-level error correction is enabled or not. A value of the mode register 280 may indicate an error correction mode of the data buffer 260 selected from multiple candidate error correction modes (e.g., enabled, disabled, partially enabled, varying levels of complexity, and the like). The mode registers 280 and 285 may be set by a memory system controller 140, in some examples. Additionally, or alternatively, the memory system 210 may receive some signaling or other indication from the host system 205 indicating the values for the mode registers 280 and 285. In some examples, a user of the system may input the requested mode register values based on a use case of the user or other parameters. Additionally, or alternatively, the allocation of on-die versus system-level error correction may be made during manufacture of the system 200.

In some examples, the error correction circuitry 265 within the data buffer 260 may include one or more logic gates or other components configured to perform varying levels of error correction. For example, the error correction circuitry 265 may support error correction in accordance with a first algorithm and a first quantity of parity bits when on-die error correction is enabled and system-level error correction is enabled using parity bits from one or more dies configured to store only parity information. Additionally, or alternatively, if system-level error correction is disabled, the error correction circuitry 265 may refrain from performing any error correction or detection on the data before transferring the data to the host system 205. If on-die error correction is disabled and system-level error correction is enabled, the error correction circuitry 265 may support error correction in accordance with a second algorithm and a second quantity of parity bits that may be greater than the first quantity. The second algorithm may be more complex and may be capable of correcting more errors per codeword than the first algorithm, in some examples. The logic within the error correction circuitry 265 may similarly support one or more other error correction algorithms based on a value of the mode register(s) 280 and a quantity of parity bits that are available. The data buffer 260 may thereby use a logic process for error correction instead of a DRAM process, or other type of process, which may improve performance of the error correction as compared with only on-die error correction or host-level error correction.

Although the system-level error correction is described herein as being performed within the data buffer 260, it is to be understood that, in some examples, the system-level error correction may be performed by any one or more components within the memory system 210 that are external to or distributed across the one or more memory dies 245.

In accordance with examples described herein, the data buffer 260 (e.g., the I/O component 270, the error correction circuitry 265, or both) may be configured to encrypt data and parity information generated by the error correction circuitry 265 as part of the system-level error correction prior to communicating the data and parity information via one of the data bus 295-a or the data bus 295-b. For example, the data buffer 260 may be configured with one or more encryption schemes that are enabled for encryption of the data and the parity information by the data buffer 260 prior to communication of the data and the parity information external to the data buffer 260. In some examples, the data buffer 260 may encrypt the data and the parity information according to a first shared key that is shared between (e.g., configured according to a handshake between) the data buffer 260 and the memory dies 245. During exchanges of data (e.g., reads, writes) between the data buffer 260 and the memory dies 245, data and parity information communicated via the data bus 295-bmay be encrypted according to the first shared key. Additionally, or alternatively, the data buffer 260 may encrypt the data and the parity information according to a second shared key that is shared between (e.g., configured according to a handshake between) the data buffer 260 and the host system 205. During exchanges of data (e.g., reads, writes) between the data buffer 260 and the host system 205, data and parity information communicated via the data bus 295-a may be encrypted according to the second shared key. The first shared key and the second shared key may be associated with a same encryption scheme (e.g., security strength) or may be associated with different encryption schemes.

In some examples, the memory dies 245 may have a capability to perform encryption or decryption according to the first shared key. In such examples, the memory dies 245 may decrypt the data and parity information received from the data buffer 260 prior to storing the data and parity information unencrypted (e.g., raw data) to the memory arrays 255. Additionally, or alternatively, the memory dies 245 may not decrypt the data and parity information received from the data buffer 260, and data stored to the memory arrays 255 may be in an encrypted (e.g., scrambled) form. In such cases, the memory dies 245 may send the encrypted data in the encrypted form back to the data buffer 260 during a read.

Although the data buffer 260 is described as performing the encryption and decryption in this example, it is to be understood that the encryption and decryption of the data, the parity information, or both may be performed by any one or more components within the memory system 210, including the error correction circuitry 265, or other circuitry distributed across or within the memory system 210.

By encrypting the data and parity information prior to communicating the data and parity information to the memory dies 245 or the host system 205, the memory system 210 may increase the security of data exchanged over the data bus 295-a and the data bus 295-b. For example, the memory system 210 may prevent a malicious actor from intercepting the data or parity information as it is communicated over one of the data buses 295 by encrypting the data and parity information during any communications of the data and parity information external to the data buffer 260. Thus, the described techniques may enable protection of system-critical data or data with a relatively high desired security.

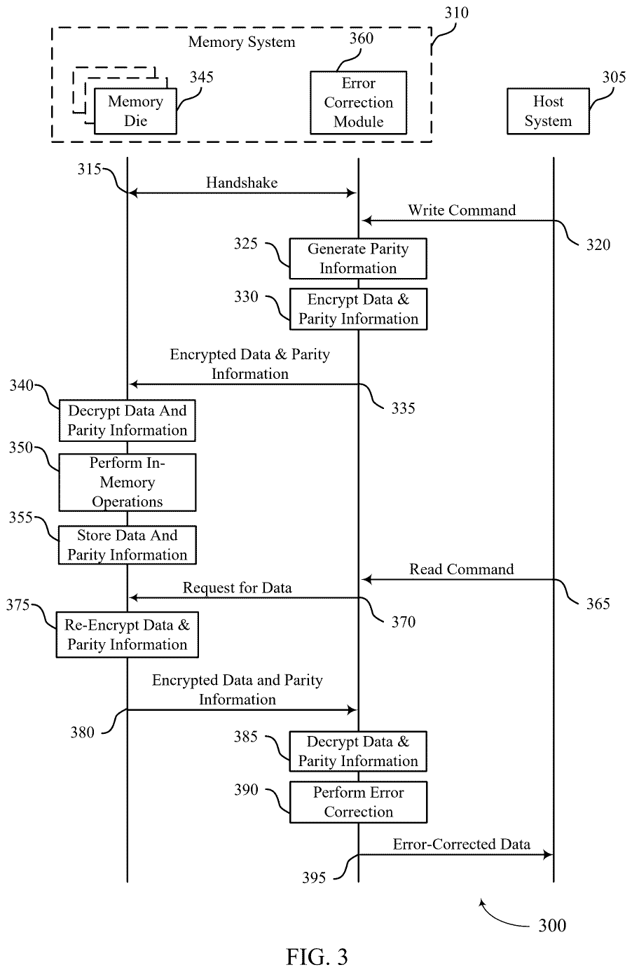

FIG. 3 shows an example of a process flow 300 that supports module-level encryption of error correction data in accordance with examples as disclosed herein. The process flow 300 may implement or be implemented by aspects of the system 100 or the system 200, as described with reference to FIGS. 1 and 2. For example, the process flow 300 illustrates exchanges of data and parity information between one or more memory dies 345 and an error correction module 360 within a memory system 310, and between the memory system 310 and a host system 305, which may represent examples of corresponding systems and dies as described with reference to FIGS. 1 and 2. The error correction module 360 may be an example of a data buffer 260 as described with reference to FIG. 2, or some other module or component comprising circuitry configured to perform error correction, error detection, encryption of parity information, or any combination thereof. In this example, the error correction module 360 may include error correction capabilities for correcting errors at the system-level prior to writing data to the memory dies 345 (e.g., as part of a write operation) or transferring data to the host system 305 (e.g., as part of a read operation).

At 315, the error correction module 360 may transmit, to the memory dies 345, an indication of an encryption scheme that is enabled for encryption of data and parity information communicated via a data bus between the error correction module 360 and the memory dies 345. In some examples, the indication of the encryption scheme may be part of a handshake procedure between the error correction module 360 and the memory dies 345. For example, the memory dies 345 may transmit an acknowledgment message in response to the indication confirming the encryption scheme that is enabled for the data and parity information. In some examples, the configuration (e.g., indication) of the encryption scheme, the acknowledgment message, or both may be based on a capability of the memory dies 345 to perform encryption (e.g., a capability to perform one or more candidate encryption schemes, a capability to perform encryption up to a threshold encryption complexity or threshold security strength).

Additionally, or alternatively, the error correction module 360 may transmit an indication of a shared key associated with the encryption scheme, where encrypting or decrypting the data and the parity information is according to the shared key. The encryption scheme that is enabled for encryption may include a scrambling sequence that is applied to bits of the data and the parity information prior to the data and the parity information being communicated over the data bus (e.g., thereby obscuring the data and parity information from being read by external entities).

At 320, the error correction module 360 may receive data for storage in the memory dies 345. For example, the error correction module 360 may receive a command from the host system 305 indicating to write the data to the memory dies 345. At 325, the error correction module 360 may generate parity information (e.g., ECC metadata) associated with the data. For example, the error correction module 360 may perform a system-level error correction on the data and may generate the parity information as part of performing the system-level error correction.

At 330, the error correction module 360 may encrypt the data and the generated parity information according to the encryption scheme. For example, the error correction module 360 may apply the scrambling sequence to the data and the generated parity information after performing the system-level correction on the data. In some examples, the error correction module 360 may select the encryption scheme from a set of candidate encryption schemes configured for encryption and parity information by the error correction module 360.

In some examples, the error correction module 360 may change the encryption scheme the error correction module 360 uses to encrypt the data and the parity information dynamically. For example, the error correction module 360 may receive (e.g., at 320) first data and second data for storage in the memory dies 345. In response to receiving the first data and the second data, the error correction module 360 may generate first parity information (e.g., according to a first system-level correction) for the first data and may generate second parity information (e.g., according to a second system-level correction) for the second data. The error correction module 360 may use a first encryption scheme (e.g., of a first security strength) to encrypt the first data and first parity information and may use a second encryption scheme (e.g., of a second security strength) to encrypt the second data and second parity information. In some examples, the error correction module 360 may select the encryption scheme for encryption of the data and the parity information based on one or more characteristics of the data, one or more operating parameters of the memory system 310, one or more power parameters (e.g., low power modes) of the memory system 310, or a combination thereof. The encryption scheme may refer to a strength of encryption, a type of algorithm used for encryption, or both.

In some other examples, the error correction module 360 may change the keying material the error correction module 360 uses to encrypt the data and the parity information dynamically. A keying material may refer to a set of raw data (e.g., input data) used to generate a key for encryption. For example, the error correction module 360 may use a first keying material (e.g., first set of input data) to encrypt the first data and first parity information and may use a second keying material (e.g., second set of input data) to encrypt the second data and second parity information. In some examples, the error correction module 360 may select the keying material for encryption of the data and the parity information based on one or more characteristics of the data, one or more operating parameters of the memory system 310, one or more power parameters (e.g., low power modes) of the memory system 310, or a combination thereof. In some examples, the error correction module 360 may change the keying material used for encryption of the data and the parity information on demand (e.g., based on feedback from the host system 305) or according to (e.g., during or at) one or more power cycles of the memory system 310.

Additionally, or alternatively, the error correction module 360 may select the encryption scheme or the keying material based on a security characteristic (e.g., a level of security) of the data or a data type. For example, data with a relatively higher desired security (e.g., classified data, personal data, highly sensitive data) may be encrypted using an encryption scheme (e.g., or keying material) with a relatively higher security strength. In an example, the error correction module 360 may use a first encryption scheme with a first security strength for encrypting first data (e.g., relatively high-security data) and may use a second encryption scheme with a second security strength less than the first security strength for encrypting second data (e.g., relatively low-security data).

At 335, the error correction module 360 may transmit the encrypted data and the encrypted parity information to the memory dies 345 (e.g., for storage of the data and the parity information at the memory dies 345, responsive to the write command from the host system 305).

In some examples, at 355, the memory dies 345 may store the encrypted data and the encrypted parity information in one or more memory cells. In such examples, the memory dies 345 may be unaware of the data corresponding to the encrypted data and the encrypted parity information the memory dies 345 receive, and the memory dies 345 may store the data and the parity information in a scrambled form (e.g., without performing any operations using the stored data).

In some other examples, at 340, the memory dies 345 may decrypt the data and the parity information according to the encryption scheme (e.g., using the shared key) prior to storing the data and the parity information unencrypted (e.g., raw data) at 355. At 350, in response to decrypting the data and the parity information, the memory dies 345 may perform one or more in-memory operations using the decrypted data (e.g., raw data). For example, the memory dies 345 may have processor-in-memory (PIM) capability. That is, the memory dies 345 may include memory cells that are coupled with or otherwise include one or more processors that may be used to perform computations on the raw data (e.g., and results of the computations may be stored in the memory cells). Additionally, or alternatively, the memory dies 345 may perform error correction on the data using on-die ECC circuitry. In some examples, the memory dies 345 may select a location for storing the data, may select an error correction scheme for performing error correction on the data, or may select one or more other storage parameters or operating parameters based on decrypting the data and/or the parity information. At 355, the memory dies 345 may store the decrypted data and the decrypted parity information (e.g., based on the storage or operating parameters determined at 350).

At 365, the error correction module 360 may receive a read command from the host system 305 that requests to read data stored at the memory dies 345. At 370 (e.g., in response to the read command), the error correction module 360 may transmit a request for the data to the memory dies 345. If the memory dies 345 store the data and the parity information in an encrypted form, the memory dies 345 may, at 380, transmit the encrypted data and the encrypted parity information to the error correction module 360 in response to the request without performing any re-encryption (e.g., skipping step 375). Alternately, if the memory dies 345 store the data and the parity information unencrypted (e.g., raw data), the memory dies may, at 375, encrypt (e.g., re-encrypt) the data and the parity information according to the encryption scheme (e.g., according to the shared key) prior to transmitting the encrypted data and the encrypted parity information at 380 to the error correction module 360.

In some examples, the memory dies 345 may use a second encryption scheme to re-encrypt the data and the parity information at 375 different from the encryption scheme used by the error correction module 360 (e.g., to encrypt the data and the parity information at 330). The second encryption scheme may have a greater security strength than the encryption scheme, or vice versa. The second encryption scheme may use a same or similar encryption algorithm as the encryption scheme used by the error correction module 360, may be based on the same shared key as used by the error correction module 360, or both. Additionally, or alternatively, the memory dies 345 may use the same encryption scheme but may use a second shared key different from the shared key used by the error correction module 360. The second shared key may correspond to a second scrambling sequence different from the scrambling sequence used to scramble the data at the error correction module 360. In some examples, the second encryption scheme, the second shared key, or both may be configured as part of the handshake at 315. For example, the error correction module 360 may transmit an indication of a first encryption scheme, first shared key, or both, enabled for encryption of data and parity information by the error correction module 360 and a second encryption scheme, second shared key, or both enabled for encryption of data and parity information by the memory dies 345.

At 380, the memory dies 345 may transmit the encrypted data and the encrypted parity information to the error correction module 360. The memory dies 345 may transmit the encrypted data and the encrypted parity information responsive to the request from the error correction module 360.

At 385, the error correction module 360 may decrypt the data and parity information received from the memory dies 345 according to the encryption scheme (e.g., according to the shared key). At 390, the error correction module 360 may perform error correction to correct one or more errors in the data using the decrypted parity information. At 395, the error correction module 360 may transmit the corrected data to the host system 305.

The described techniques may thereby provide for protection of the parity information that is exchanged via a bus between the error correction module 360 and the memory dies 345 within the memory system 310.

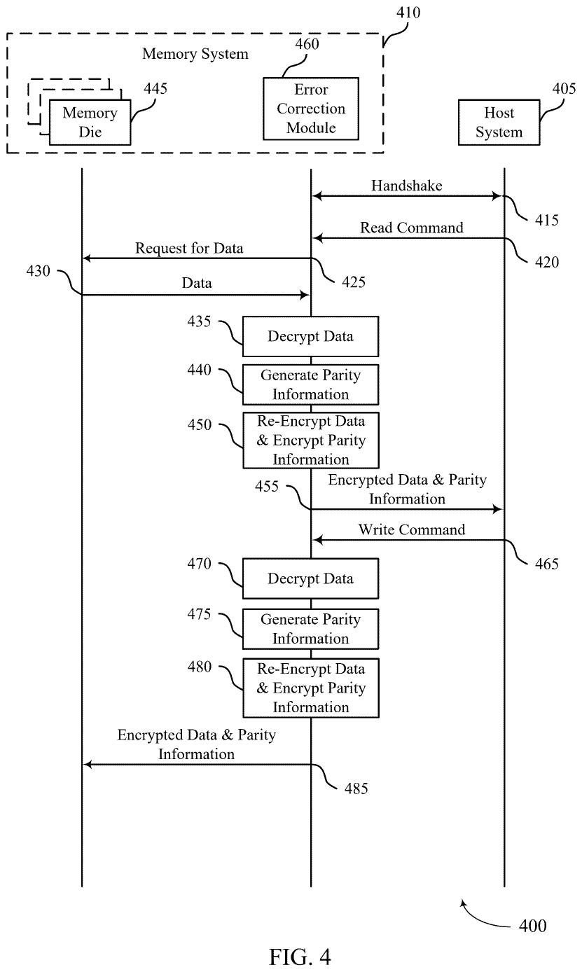

FIG. 4 shows an example of a process flow 400 supports module-level encryption of error correction data in accordance with examples as disclosed herein. The process flow 400 may implement or be implemented by aspects of the system 100 or the system 200, as described with reference to FIGS. 1 and 2. For example, the process flow 400 illustrates exchanges of data and parity information between one or more memory dies 445 and an error correction module 460 within a memory system 410, and between the memory system 410 and a host system 405, which may represent examples of corresponding systems and dies as described with reference to FIGS. 1 and 2. The error correction module 460 may be an example of a data buffer 260 as described with reference to FIG. 2. In this example, the error correction module 460 may include error correction capabilities for correcting errors at the system-level prior to transferring data to the host system 405 (e.g., as part of a read operation) or writing data to the memory dies 445 (e.g., as part of a write operation).

At 415, the host system 405 may transmit, to the error correction module 460, an indication of an encryption scheme that is enabled for encryption of data and parity information communicated via a data bus between the host system 405 and the error correction module 460. In some examples, the indication of the encryption scheme may be part of a handshake procedure between the host system 405 and the error correction module 460. For example, the error correction module 460 may transmit an acknowledgment message in response to the indication confirming the encryption scheme that is enabled for the data and parity information. In some examples, the configuration (e.g., indication) of the encryption scheme, the acknowledgment message, or both may be based on a capability of the error correction module 460 to perform encryption (e.g., a capability to perform one or more candidate encryption schemes, a capability to perform encryption up to a threshold encryption complexity or threshold security strength).

Additionally, or alternatively, the host system 405 may transmit an indication of a shared key associated with the encryption scheme, where encrypting or decrypting the data and the parity information is according to the shared key. The encryption scheme that is enabled for encryption may include a scrambling sequence that is applied to bits of the data and the parity information prior to the data and the parity information being communicated over the data bus (e.g., thereby obscuring the data and parity information from being read by external entities).

In some examples, the host system 405 may indicate a first encryption scheme enabled for encryption of data and parity information communicated via a first data bus between the host system 405 and the error correction module 460 and a second encryption scheme enabled for encryption of data and parity information communicated via a second data bus between the error correction module 460 and the memory dies 445. In such examples, the error correction module 460 may transmit an indication (e.g., forward the indication) of the second encryption scheme to the memory dies 445 (e.g., as part of a second handshake procedure between the error correction module 460 and the memory dies 445). The second encryption scheme may have a greater security strength than the encryption scheme, or vice versa.

Additionally, or alternatively, the host system 405 may indicate a first shared key enabled for encryption of data and parity information communicated via the first data bus between the host system 405 and the error correction module 460 and a second shared key enabled for encryption of data and parity information communicated via the second data bus between the error correction module 460 and the memory dies 445. The first shared key and second shared key may be associated with a same encryption scheme or different encryption schemes. In such examples, the error correction module 460 may transmit an indication (e.g., forward the indication) of the second shared key to the memory dies 445 (e.g., as part of a second handshake procedure between the error correction module 460 and the memory dies 445). The second shared key may correspond to a second scrambling sequence applied to data (e.g., raw data) that is different from a first scrambling sequence applied to data according to the first shared key.

In some examples, the encryption scheme or shared key that is enabled for encryption of the data and the parity information, such as a security strength of the encryption scheme or shared key, may be based on a level of access (e.g., restricted access, open/free access) of the first data bus and/or the second data bus, a security characteristic (e.g., desired security level) of the data, a performance metric (e.g., latency metric, latency requirement/threshold) associated with the data, an application associated with the data, or a combination thereof.

At 420, the error correction module 460 may receive a read command from the host system 405 that requests to read data stored at the memory dies 445. At 425 (e.g., in response to the read command), the error correction module 460 may transmit a request for the data to the memory dies 445. At 430, the memory dies 445 may transmit the data to the error correction module 460.

At 435, the error correction module 460 may decrypt the data received from the memory dies 445 according to an encryption scheme and/or a shared key. Decrypting the data and parity information received from the memory dies 445 may be according to the second encryption scheme or the second shared key enabled for communications via the second data bus between the error correction module 460 and the memory dies 445. At 440, the error correction module 460 may generate parity information (e.g., ECC metadata) associated with the data. For example, the error correction module 460 may perform a system-level error correction on the data and may generate the parity information as part of performing the system-level error correction.

At 450, the error correction module 460 may re-encrypt the data and encrypt the generated parity information according to an encryption scheme and/or a shared key. Re-encrypting the data and encrypting the generated parity information may be according to the first encryption scheme or the first shared key enabled for communications via the first data bus between the error correction module 460 and the host system 405. For example, the error correction module 460 may apply a scrambling sequence (e.g., the first scrambling sequence) to the data and the generated parity information after performing the system-level correction on the data. In some examples, the error correction module 460 may select the encryption scheme from a set of candidate encryption schemes configured for encryption and parity information by the error correction module 460.

In some examples, the error correction module 460 may change the encryption scheme the error correction module 460 uses to encrypt the data and the parity information dynamically. For example, the error correction module 460 may receive (e.g., at 430) first data and second data from the memory dies 445. In response to receiving the first data and the second data, the error correction module 460 may generate first parity information (e.g., according to a first system-level correction) for the first data and may generate second parity information (e.g., according to a second system-level correction) for the second data. The error correction module 460 may use a first encryption scheme (e.g., of a first security strength) to encrypt the first data and first parity information and may use a second encryption scheme (e.g., of a second security strength) to encrypt the second data and second parity information. In some examples, the error correction module 460 may select the encryption scheme for encryption of the data and the parity information based on one or more characteristics of the data, one or more operating parameters of the memory system 410, one or more power parameters (e.g., low power modes) of the memory system 410, or a combination thereof.

In some other examples, the error correction module 460 may change the keying material the error correction module 460 uses to encrypt the data and the parity information dynamically. A keying material may refer to a set of raw data (e.g., input data) used to generate a key for encryption. For example, the error correction module 460 may use a first keying material (e.g., first set of input data) to encrypt the first data and first parity information and may use a second keying material (e.g., second set of input data) to encrypt the second data and second parity information. In some examples, the error correction module 460 may select the keying material for encryption of the data and the parity information based on one or more characteristics of the data, one or more operating parameters of the memory system 410, one or more power parameters (e.g., low power modes) of the memory system 410, or a combination thereof. In some examples, the error correction module 460 may change the keying material used for encryption of the data and the parity information on demand (e.g., based on feedback from the host system 405) or according to (e.g., during or at) one or more power cycles of the memory system 410.

Additionally, or alternatively, the error correction module 460 may select the encryption scheme or keying material based on a security characteristic (e.g., a level of security) of the data or a data type. For example, data with a relatively higher desired security (e.g., classified data, personal data, highly sensitive data) may be encrypted using an encryption scheme (e.g., or keying material) with a relatively higher security strength. In an example, the error correction module 460 may use a first encryption scheme with a first security strength for encrypting first data (e.g., relatively high-security data) and may use a second encryption scheme with a second security strength less than the first security strength for encrypting second data (e.g., relatively low-security data).

At 455, the error correction module 460 may transmit the encrypted data and the encrypted parity information to the host system 405. The error correction module 460 may transmit the encrypted data and the encrypted parity information responsive to the read command from the host system 405.

At 465, the error correction module 460 may receive data for storage in the memory dies 445. For example, the error correction module 460 may receive a command from the host system 405 indicating to write the data to the memory dies 445. At 470, the error correction module 460 may decrypt the data received from the host system 405 according to an encryption scheme and/or a shared key. Decrypting the data received from the host system 405 may be according to the first encryption scheme or the first shared key enabled for communications via the first data bus between the error correction module 460 and the host system 405.

At 475, the error correction module 460 may generate parity information (e.g., ECC metadata) associated with the data. For example, the error correction module 460 may perform a system-level error correction on the data and may generate the parity information as part of performing the system-level error correction.

At 480, the error correction module 360 may re-encrypt the data and encrypt the generated parity information according to an encryption scheme and/or a shared key. Re-encrypting the data and encrypting the generated parity information may be according to the second encryption scheme or the second shared key enabled for communications via the second data bus between the error correction module 460 and the memory dies 445. For example, the error correction module 460 may apply a scrambling sequence (e.g., the second scrambling sequence) to the data and the generated parity information after performing the system-level correction on the data.

In some examples, the error correction module 460 may change the encryption scheme the error correction module 460 uses to encrypt the data and the parity information dynamically. For example, the error correction module 460 may receive (e.g., at 465) first data and second data from the host system 405. In response to receiving the first data and the second data, the error correction module 460 may generate first parity information (e.g., according to a first system-level correction) for the first data and may generate second parity information (e.g., according to a second system-level correction) for the second data. The error correction module 460 may use a first encryption scheme (e.g., of a first security strength) to encrypt the first data and first parity information and may use a second encryption scheme (e.g., of a second security strength) to encrypt the second data and second parity information. In some examples, the error correction module 460 may select the encryption scheme for encryption of the data and the parity information based on one or more characteristics of the data, one or more operating parameters of the memory system 410, one or more power parameters (e.g., low power modes) of the memory system 410, or a combination thereof.

In some other examples, the error correction module 460 may change the keying material the error correction module 460 uses to encrypt the data and the parity information dynamically. A keying material may refer to a set of raw data (e.g., input data) used to generate a key for encryption. For example, the error correction module 460 may use a first keying material (e.g., first input data) to encrypt the first data and first parity information and may use a second encryption scheme (e.g., second input data) to encrypt the second data and second parity information. In some examples, the error correction module 460 may select the keying material for encryption of the data and the parity information based on one or more characteristics of the data, one or more operating parameters of the memory system 410, one or more power parameters (e.g., low power modes) of the memory system 410, or a combination thereof. In some examples, the error correction module 460 may change the keying material used for encryption of the data and the parity information on demand (e.g., based on feedback from the host system 405) or according to (e.g., during or at) one or more power cycles of the memory system 410.

Additionally, or alternatively, the error correction module 460 may select the encryption scheme or the keying material based on a security characteristic (e.g., a level of security) of the data or a data type. For example, data with a relatively higher desired security (e.g., classified data, personal data, highly sensitive data) may be encrypted using an encryption scheme (e.g., or keying material) with a relatively higher security strength. In an example, the error correction module 460 may use a first encryption scheme with a first security strength for encrypting first data (e.g., relatively high-security data) received from the host system 405 and may use a second encryption scheme with a second security strength less than the first security strength for encrypting second data (e.g., relatively low-security data) received from the host system 405.

At 485, the error correction module 460 may transmit the encrypted data and the encrypted parity information to the memory dies 445 (e.g., for storage of the data and the parity information at the memory dies 445, responsive to the write command from the host system 405).

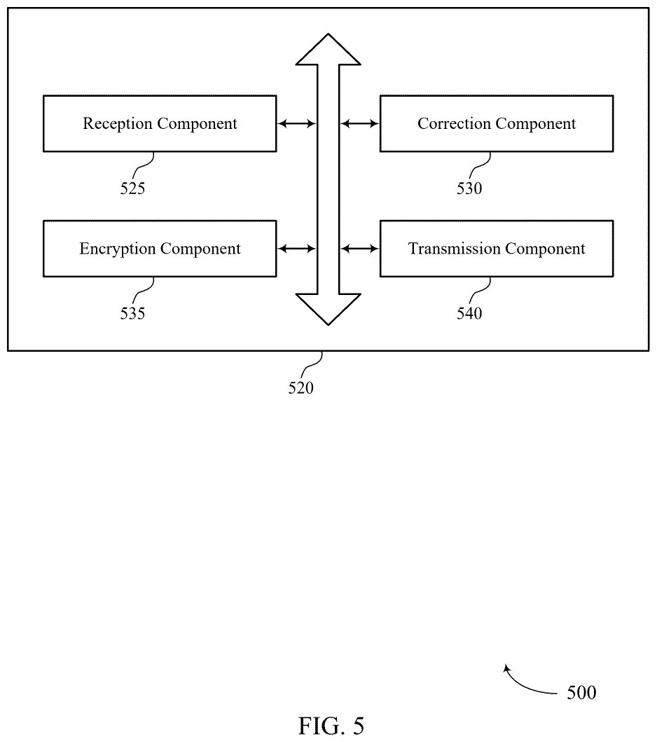

FIG. 5 shows a block diagram 500 of a memory system 520 that supports encryption schemes for communication of error correction data in accordance with examples as disclosed herein. The memory system 520 may be an example of aspects of a memory system as described with reference to FIGS. 1 through 4. The memory system 520, or various components thereof, may be an example of means for performing various aspects of encryption schemes for communication of error correction data as described herein. For example, the memory system 520 may include a reception component 525, a correction component 530, an encryption component 535, a transmission component 540, or any combination thereof. Each of these components, or components of subcomponents thereof (e.g., one or more processors, one or more memories), may communicate, directly or indirectly, with one another (e.g., via one or more buses).

The reception component 525 may be configured as or otherwise support a means for receiving, at error correction circuitry of the memory system and from a host system, an indication of a shared key associated with an encryption scheme that is enabled for data and parity information communicated between the error correction circuitry and the host system. In some examples, the reception component 525 may be configured as or otherwise support a means for receiving the data at the error correction circuitry from one or more memory dies of the memory system. The correction component 530 may be configured as or otherwise support a means for generating, by the error correction circuitry based at least in part on performing system-level error correction of the data, the parity information associated with the data. The encryption component 535 may be configured as or otherwise support a means for encrypting, according to the encryption scheme and based at least in part on the shared key, the data and the parity information. The transmission component 540 may be configured as or otherwise support a means for transmitting, from the error correction circuitry to the host system, the encrypted data and the encrypted parity information.

In some examples, the data received from the one or more memory dies includes encrypted data, and the encryption component 535 may be configured as or otherwise support a means for decrypting, by the error correction circuitry, the encrypted data received from the one or more memory dies to obtain the data, the decrypting according to a second encryption scheme different from the encryption scheme, where generating the parity information associated with the data is based at least in part on decrypting the encrypted data received from the one or more memory dies.

In some examples, the reception component 525 may be configured as or otherwise support a means for receiving, at the error correction circuitry from the host system, a second indication of a second shared key associated with the second encryption scheme that is enabled for the data and the parity information communicated between the error correction circuitry and the one or more memory dies, where decrypting the encrypted data received from the one or more memory dies is based at least in part on the second shared key.

In some examples, a first level of encryption associated with the encryption scheme that is enabled for communication between the error correction circuitry and the host system is greater than a second level of encryption associated with the second encryption scheme that is enabled for communication between the error correction circuitry and the one or more memory dies.

In some examples, the reception component 525 may be configured as or otherwise support a means for receiving, at the error correction circuitry from the host system, encrypted second data corresponding to second data to be stored in the one or more memory dies. In some examples, the encryption component 535 may be configured as or otherwise support a means for decrypting, by the error correction circuitry according to the encryption scheme, the encrypted second data to obtain the second data. In some examples, the correction component 530 may be configured as or otherwise support a means for generating, by the error correction circuitry based at least in part on performing the system-level error correction of the second data, second parity information associated with the second data, where generating the second parity information is based at least in part on decrypting the encrypted second data to obtain the second data.

In some examples, the encryption component 535 may be configured as or otherwise support a means for re-encrypting, by the error correction circuitry after performing the system-level error correction of the second data, the second data according to a second encryption scheme different from the encryption scheme. In some examples, the encryption component 535 may be configured as or otherwise support a means for encrypting, by the error correction circuitry, the second parity information associated with the second data according to the second encryption scheme. In some examples, the transmission component 540 may be configured as or otherwise support a means for transmitting, from the error correction circuitry to the one or more memory dies, the re-encrypted second data and the encrypted second parity information.

In some examples, the transmission component 540 may be configured as or otherwise support a means for transmitting, from the error correction circuitry to the host system, an acknowledgment message confirming the encryption scheme that is enabled for the data and the parity information, where encrypting the data and the parity information according to the encryption scheme is based at least in part on the acknowledgment message.

In some examples, transmitting the acknowledgment message is based at least in part on a capability of the error correction circuitry to support encryption using the shared key associated with the encryption scheme.

In some examples, the encryption scheme that is enabled for the data and the parity information is based at least in part on a level of access associated with a data channel between the error correction circuitry and the host system, a security characteristic of the data, a performance metric associated with the data, or a combination thereof.

In some examples, the reception component 525 may be configured as or otherwise support a means for receiving, at the error correction circuitry, second data from the one or more memory dies. In some examples, the correction component 530 may be configured as or otherwise support a means for generating, by the error correction circuitry based at least in part on performing the system-level error correction of the second data, second parity information associated with the second data. In some examples, the encryption component 535 may be configured as or otherwise support a means for encrypting, by the error correction circuitry according to a second encryption scheme different from the encryption scheme, the second data and the second parity information. In some examples, the transmission component 540 may be configured as or otherwise support a means for transmitting, from the error correction circuitry to the host system, the encrypted second data and the encrypted second parity information.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

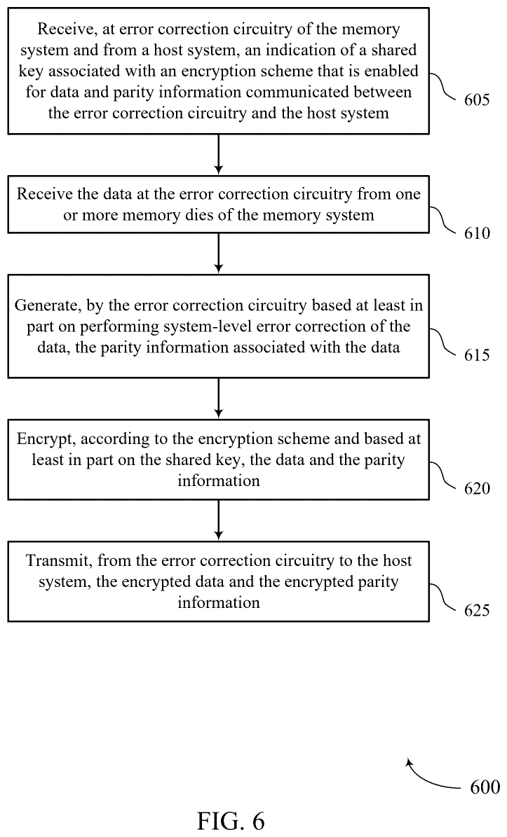

FIG. 6 shows a flowchart illustrating a method 600 that supports encryption schemes for communication of error correction data in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, at error correction circuitry of the memory system and from a host system, an indication of a shared key associated with an encryption scheme that is enabled for data and parity information communicated between the error correction circuitry and the host system. In some examples, aspects of the operations of 605 may be performed by a reception component 525 as described with reference to FIG. 5.

At 610, the method may include receiving the data at the error correction circuitry from one or more memory dies of the memory system. In some examples, aspects of the operations of 610 may be performed by a reception component 525 as described with reference to FIG. 5.

At 615, the method may include generating, by the error correction circuitry based at least in part on performing system-level error correction of the data, the parity information associated with the data. In some examples, aspects of the operations of 615 may be performed by a correction component 530 as described with reference to FIG. 5.

At 620, the method may include encrypting, according to the encryption scheme and based at least in part on the shared key, the data and the parity information. In some examples, aspects of the operations of 620 may be performed by an encryption component 535 as described with reference to FIG. 5.

At 625, the method may include transmitting, from the error correction circuitry to the host system, the encrypted data and the encrypted parity information. In some examples, aspects of the operations of 625 may be performed by a transmission component 540 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving, at error correction circuitry of the memory system and from a host system, an indication of a shared key associated with an encryption scheme that is enabled for data and parity information communicated between the error correction circuitry and the host system; receiving the data at the error correction circuitry from one or more memory dies of the memory system; generating, by the error correction circuitry based at least in part on performing system-level error correction of the data, the parity information associated with the data; encrypting, according to the encryption scheme and based at least in part on the shared key, the data and the parity information; and transmitting, from the error correction circuitry to the host system, the encrypted data and the encrypted parity information.
Aspect 2: The method, apparatus, or non-transitory computer-readable medium of aspect 1, where the data received from the one or more memory dies includes encrypted data and the method, apparatuses, and non-transitory computer-readable medium further includes operations, features, circuitry, logic, means, or instructions, or any combination thereof for decrypting, by the error correction circuitry, the encrypted data received from the one or more memory dies to obtain the data, the decrypting according to a second encryption scheme different from the encryption scheme, where generating the parity information associated with the data is based at least in part on decrypting the encrypted data received from the one or more memory dies.
Aspect 3: The method, apparatus, or non-transitory computer-readable medium of aspect 2, further including operations, features, circuitry, logic, means, or instructions, or any combination thereof for receiving, at the error correction circuitry from the host system, a second indication of a second shared key associated with the second encryption scheme that is enabled for the data and the parity information communicated between the error correction circuitry and the one or more memory dies, where decrypting the encrypted data received from the one or more memory dies is based at least in part on the second shared key.
Aspect 4: The method, apparatus, or non-transitory computer-readable medium of any of aspects 2 through 3, where a first level of encryption associated with the encryption scheme that is enabled for communication between the error correction circuitry and the host system is greater than a second level of encryption associated with the second encryption scheme that is enabled for communication between the error correction circuitry and the one or more memory dies.
Aspect 5: The method, apparatus, or non-transitory computer-readable medium of any of aspects 1 through 4, further including operations, features, circuitry, logic, means, or instructions, or any combination thereof for receiving, at the error correction circuitry from the host system, encrypted second data corresponding to second data to be stored in the one or more memory dies; decrypting, by the error correction circuitry according to the encryption scheme, the encrypted second data to obtain the second data; and generating, by the error correction circuitry based at least in part on performing the system-level error correction of the second data, second parity information associated with the second data, where generating the second parity information is based at least in part on decrypting the encrypted second data to obtain the second data.
Aspect 6: The method, apparatus, or non-transitory computer-readable medium of aspect 5, further including operations, features, circuitry, logic, means, or instructions, or any combination thereof for re-encrypting, by the error correction circuitry after performing the system-level error correction of the second data, the second data according to a second encryption scheme different from the encryption scheme; encrypting, by the error correction circuitry, the second parity information associated with the second data according to the second encryption scheme; and transmitting, from the error correction circuitry to the one or more memory dies, the re-encrypted second data and the encrypted second parity information.
Aspect 7: The method, apparatus, or non-transitory computer-readable medium of any of aspects 1 through 6, further including operations, features, circuitry, logic, means, or instructions, or any combination thereof for transmitting, from the error correction circuitry to the host system, an acknowledgment message confirming the encryption scheme that is enabled for the data and the parity information, where encrypting the data and the parity information according to the encryption scheme is based at least in part on the acknowledgment message.
Aspect 8: The method, apparatus, or non-transitory computer-readable medium of aspect 7, where transmitting the acknowledgment message is based at least in part on a capability of the error correction circuitry to support encryption using the shared key associated with the encryption scheme.
Aspect 9: The method, apparatus, or non-transitory computer-readable medium of any of aspects 1 through 8, where the encryption scheme that is enabled for the data and the parity information is based at least in part on a level of access associated with a data channel between the error correction circuitry and the host system, a security characteristic of the data, a performance metric associated with the data, or a combination thereof.
Aspect 10: The method, apparatus, or non-transitory computer-readable medium of any of aspects 1 through 9, further including operations, features, circuitry, logic, means, or instructions, or any combination thereof for receiving, at the error correction circuitry, second data from the one or more memory dies; generating, by the error correction circuitry based at least in part on performing the system-level error correction of the second data, second parity information associated with the second data; encrypting, by the error correction circuitry according to a second encryption scheme different from the encryption scheme, the second data and the second parity information; and transmitting, from the error correction circuitry to the host system, the encrypted second data and the encrypted second parity information.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 11: An apparatus, including: one or more memory dies configured to store data in one or more memory cells; and error correction circuitry coupled with the one or more memory dies and configured to perform system-level error correction of the data prior to transmission of the data to a host system, the error correction circuitry configured to: receive, from the host system, an indication of a shared key associated with an encryption scheme that is enabled for data and parity information communicated between the error correction circuitry and the host system; receive the data from the one or more memory dies; generate, based at least in part on performing the system-level error correction of the data, the parity information associated with the data; encrypt, according to the encryption scheme and based at least in part on the shared key, the data and the parity information; and transmit, to the host system, the encrypted data and the encrypted parity information.
Aspect 12: The apparatus of aspect 11, where the data received from the one or more memory dies includes encrypted data, where the error correction circuitry is further configured to: decrypt the encrypted data received from the one or more memory dies to obtain the data, the decrypting according to a second shared key associated with the encryption scheme or a second encryption scheme different from the encryption scheme, where generating the parity information associated with the data is based at least in part on decrypting the encrypted data received from the one or more memory dies.
Aspect 13: The apparatus of aspect 12, where the error correction circuitry is further configured to: receive, from the host system, a second indication of the second shared key that is enabled for the data and the parity information communicated between the error correction circuitry and the one or more memory dies, where decrypting the encrypted data received from the one or more memory dies is based at least in part on the second shared key.
Aspect 14: The apparatus of any of aspects 12 through 13, where a first level of encryption associated with the encryption scheme that is enabled for communication between the error correction circuitry and the host system has greater security strength than a second level of encryption associated with the second encryption scheme that is enabled for communication between the error correction circuitry and the one or more memory dies.
Aspect 15: The apparatus of any of aspects 11 through 14, where the error correction circuitry is further configured to: receive, from the host system, encrypted second data corresponding to second data to be stored in the one or more memory dies; decrypt, according to the encryption scheme, the encrypted second data to obtain the second data; and generate, based at least in part on performing the system-level error correction of the second data, second parity information associated with the second data, where generating the second parity information is based at least in part on decrypting the encrypted second data to obtain the second data.
Aspect 16: The apparatus of aspect 15, where the error correction circuitry is further configured to: re-encrypt, after performing the system-level error correction of the second data, the second data according to a second shared key associated with the encryption scheme or a second encryption scheme different from the encryption scheme; encrypt the second parity information associated with the second data according to the second shared key or the second encryption scheme; and transmit the re-encrypted second data and the encrypted second parity information to the one or more memory dies.
Aspect 17: The apparatus of any of aspects 11 through 16, where the error correction circuitry is further configured to: transmit, to the host system, an acknowledgment message confirming the encryption scheme that is enabled for the data and the parity information, where encrypting the data and the parity information according to the encryption scheme is based at least in part on the acknowledgment message.
Aspect 18: The apparatus of aspect 17, where transmitting the acknowledgment message is based at least in part on a capability of the error correction circuitry to support encryption using the shared key associated with the encryption scheme.
Aspect 19: The apparatus of any of aspects 11 through 18, where the encryption scheme that is enabled for the data and the parity information is based at least in part on a level of access associated with a data channel between the error correction circuitry and the host system, a security characteristic of the data, a performance metric associated with the data, or a combination thereof.
Aspect 20: The apparatus of any of aspects 11 through 19, where the error correction circuitry is further configured to: receive second data from the one or more memory dies; generate, based at least in part on performing the system-level error correction of the second data, second parity information associated with the second data; encrypt, according to a second shared key associated with the encryption scheme or a second encryption scheme different from the encryption scheme, the second data and the second parity information; and transmit, to the host system, the encrypted second data and the encrypted second parity information.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memory dies configured to store data in one or more memory cells; and
error correction circuitry coupled with the one or more memory dies and configured to perform system-level error correction of the data prior to transmission of the data to a host system, the error correction circuitry configured to:
receive, from the host system, an indication of a shared key associated with an encryption scheme that is enabled for data and parity information communicated between the error correction circuitry and the host system;
receive the data from the one or more memory dies;
generate, based at least in part on performing the system-level error correction of the data, the parity information associated with the data;
encrypt, according to the encryption scheme and based at least in part on the shared key, the data and the parity information; and
transmit, to the host system, the encrypted data and the encrypted parity information.

2. The apparatus of claim 1, wherein the data received from the one or more memory dies comprises encrypted data, wherein the error correction circuitry is further configured to:
decrypt the encrypted data received from the one or more memory dies to obtain the data, the decrypting according to a second shared key associated with the encryption scheme or a second encryption scheme different from the encryption scheme, wherein generating the parity information associated with the data is based at least in part on decrypting the encrypted data received from the one or more memory dies.

3. The apparatus of claim 2, wherein the error correction circuitry is further configured to:
receive, from the host system, a second indication of the second shared key that is enabled for the data and the parity information communicated between the error correction circuitry and the one or more memory dies, wherein decrypting the encrypted data received from the one or more memory dies is based at least in part on the second shared key.

4. The apparatus of claim 2, wherein a first level of encryption associated with the encryption scheme that is enabled for communication between the error correction circuitry and the host system has greater security strength than a second level of encryption associated with the second encryption scheme that is enabled for communication between the error correction circuitry and the one or more memory dies.

5. The apparatus of claim 1, wherein the error correction circuitry is further configured to:
receive, from the host system, encrypted second data corresponding to second data to be stored in the one or more memory dies;
decrypt, according to the encryption scheme, the encrypted second data to obtain the second data; and
generate, based at least in part on performing the system-level error correction of the second data, second parity information associated with the second data, wherein generating the second parity information is based at least in part on decrypting the encrypted second data to obtain the second data.

6. The apparatus of claim 5, wherein the error correction circuitry is further configured to:
re-encrypt, after performing the system-level error correction of the second data, the second data according to a second shared key associated with the encryption scheme or a second encryption scheme different from the encryption scheme;
encrypt the second parity information associated with the second data according to the second shared key or the second encryption scheme; and
transmit the re-encrypted second data and the encrypted second parity information to the one or more memory dies.

7. The apparatus of claim 1, wherein the error correction circuitry is further configured to:
transmit, to the host system, an acknowledgment message confirming the encryption scheme that is enabled for the data and the parity information, wherein encrypting the data and the parity information according to the encryption scheme is based at least in part on the acknowledgment message.

8. The apparatus of claim 7, wherein transmitting the acknowledgment message is based at least in part on a capability of the error correction circuitry to support encryption using the shared key associated with the encryption scheme.

9. The apparatus of claim 1, wherein the encryption scheme that is enabled for the data and the parity information is based at least in part on a level of access associated with a data channel between the error correction circuitry and the host system, a security characteristic of the data, a performance metric associated with the data, or a combination thereof.

10. The apparatus of claim 1, wherein the error correction circuitry is further configured to:
receive second data from the one or more memory dies;
generate, based at least in part on performing the system-level error correction of the second data, second parity information associated with the second data;
encrypt, according to a second shared key associated with the encryption scheme or a second encryption scheme different from the encryption scheme, the second data and the second parity information; and
transmit, to the host system, the encrypted second data and the encrypted second parity information.

11. A method by a memory system, comprising:
receiving, at error correction circuitry of the memory system and from a host system, an indication of a shared key associated with an encryption scheme that is enabled for data and parity information communicated between the error correction circuitry and the host system;
receiving the data at the error correction circuitry from one or more memory dies of the memory system;
generating, by the error correction circuitry based at least in part on performing system-level error correction of the data, the parity information associated with the data;
encrypting, according to the encryption scheme and based at least in part on the shared key, the data and the parity information; and
transmitting, from the error correction circuitry to the host system, the encrypted data and the encrypted parity information.

12. The method of claim 11, wherein the data received from the one or more memory dies comprises encrypted data, the method further comprising:
decrypting, by the error correction circuitry, the encrypted data received from the one or more memory dies to obtain the data, the decrypting according to a second encryption scheme different from the encryption scheme, wherein generating the parity information associated with the data is based at least in part on decrypting the encrypted data received from the one or more memory dies.

13. The method of claim 12, further comprising:
receiving, at the error correction circuitry from the host system, a second indication of a second shared key associated with the second encryption scheme that is enabled for the data and the parity information communicated between the error correction circuitry and the one or more memory dies, wherein decrypting the encrypted data received from the one or more memory dies is based at least in part on the second shared key.

14. The method of claim 12, wherein a first level of encryption associated with the encryption scheme that is enabled for communication between the error correction circuitry and the host system is greater than a second level of encryption associated with the second encryption scheme that is enabled for communication between the error correction circuitry and the one or more memory dies.

15. The method of claim 11, further comprising:
receiving, at the error correction circuitry from the host system, encrypted second data corresponding to second data to be stored in the one or more memory dies;
decrypting, by the error correction circuitry according to the encryption scheme, the encrypted second data to obtain the second data; and
generating, by the error correction circuitry based at least in part on performing the system-level error correction of the second data, second parity information associated with the second data, wherein generating the second parity information is based at least in part on decrypting the encrypted second data to obtain the second data.

16. The method of claim 15, further comprising:
re-encrypting, by the error correction circuitry after performing the system-level error correction of the second data, the second data according to a second encryption scheme different from the encryption scheme;
encrypting, by the error correction circuitry, the second parity information associated with the second data according to the second encryption scheme; and
transmitting, from the error correction circuitry to the one or more memory dies, the re-encrypted second data and the encrypted second parity information.

17. The method of claim 11, further comprising:
transmitting, from the error correction circuitry to the host system, an acknowledgment message confirming the encryption scheme that is enabled for the data and the parity information, wherein encrypting the data and the parity information according to the encryption scheme is based at least in part on the acknowledgment message.

18. The method of claim 17, wherein transmitting the acknowledgment message is based at least in part on a capability of the error correction circuitry to support encryption using the shared key associated with the encryption scheme.

19. The method of claim 11, wherein the encryption scheme that is enabled for the data and the parity information is based at least in part on a level of access associated with a data channel between the error correction circuitry and the host system, a security characteristic of the data, a performance metric associated with the data, or a combination thereof.

20. The method of claim 11, further comprising:
receiving, at the error correction circuitry, second data from the one or more memory dies;
generating, by the error correction circuitry based at least in part on performing the system-level error correction of the second data, second parity information associated with the second data;
encrypting, by the error correction circuitry according to a second encryption scheme different from the encryption scheme, the second data and the second parity information; and
transmitting, from the error correction circuitry to the host system, the encrypted second data and the encrypted second parity information.

21. A non-transitory computer-readable medium storing code, the code comprising instructions executable by one or more processors to:
receive, at error correction circuitry of a memory system and from a host system, an indication of a shared key associated with an encryption scheme that is enabled for data and parity information communicated between the error correction circuitry and the host system;
receive the data at the error correction circuitry from one or more memory dies of the memory system;
generate, by the error correction circuitry based at least in part on performing system-level error correction of the data, the parity information associated with the data;
encrypt, according to the encryption scheme and based at least in part on the shared key, the data and the parity information; and
transmit, from the error correction circuitry to the host system, the encrypted data and the encrypted parity information.
